(19) United States
(12) Patent Application Publication
(10) Pub. No.: US 2007/0234407 A1
(43) Pub. Date: Oct. 4, 2007

(54) Method for Authenticating a Communications Unit Using a Permanently Programmed Secret Codeword

(75) Inventors: Hermann Granzer, Pocking (DE); Ralf Holynski, Oberpframmern (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munchen (DE)

(21) Appl. No.: 11/596,730

(22) PCT Filed: Mar. 18, 2005
(86) PCT No.: PCT/EP05/51261

§ 371 Date: Nov. 16, 2006

(30) Foreign Application Priority Data
May 18, 2004 (DE) 10 2004 024 648.3

(51) Int. Cl. H04L 9/32

(52) U.S. Cl. 726/4

(57) ABSTRACT

In one aspect, a method for authenticating a communications unit is provided. A secret code word is programmed in a permanent memory in order to reliably verify the communications unit, and during a logging-in process of the communications unit to a service provider in a communications network, the secret code word is used for generating a message that is sent to the service provider. This message is used for verifying whether the communications unit authenticated therewith is authorized to obtain a service. A communications unit, which is connected to a communications network via an access point, is clearly identified. As a result, it is ensured that services of a communications network are obtained only with corresponding appropriate communications units that are authorized by the communications network operator.

### CROSS REFERENCE TO RELATED APPLICATIONS

This application is the U.S. National Stage of International Application No. PCT/EP2005/051261, filed Mar. 18, 2005 and claims the benefit thereof. The International Application claims the benefits of German application No. 102004024648.3 DE filed May 18, 2004, both of the applications are incorporated by reference herein in their entirety.

### FIELD OF INVENTION

The invention relates to a method for authenticating a communications unit.

### BACKGROUND OF INVENTION

According to definition a communications unit is a terminal device which is connected to a communications network via an access point.

On the other hand, a communications unit is also a user interface via which the user can exchange messages of a specific type over distances by using services of the communications network. In this case the communications unit enables the user to access the services that are provided by the operator of the communications network and that are referred to as the capability of the communications network to transmit information of a specific type, such as, for example, voice, images or data.

Depending on the type of information there are different services which can be made available by a communications network—such as, for example: voice or video transmission, packet-oriented or even connection-oriented transmission of data such as when accessing the internet and using its services WWW, FTP or e-mail, accessing companies' inhouse networks or downloading, subject to payment of a fee, music and video files that are made available by service providers on data stores.

In conventional communications networks such as, for example, the traditional telephone landline network, the communications units are connected on a permanently wired basis to an access point to the communications network. The situation is different with the modem communications networks such as mobile radio networks or packet—and connection-oriented data networks. In these communications networks a communications unit can be connected to the communications network at any access points at different locations.

Communications units of this type which can be connected at arbitrary access points at different locations may be, for example, mobile telephones, portable computers (known as laptops), mobile devices without keyboard (called PDAs), or mobile devices without full desktop functionality but with a defined set of functions (called organizers); all these types of communications units must be specially equipped with a network card or a mobile radio module in order to access a communications network.

With these modem communications networks, which permit access via arbitrary access points, the unambiguous and reliable identification of a user plays a major role, in particular because only the rightful user may be granted access to certain data or services. One example of this are corporate networks which only the members of the relevant organization are allowed to access.

A further example are mobile radio networks in which only particular SIM cards specified by the operator may be used. SIM cards are modules which are inserted into a communications unit and serve to authenticate the user of the communications unit by input of a PIN code.

Methods which authenticate the user of a communications unit when he or she registers with or signs on to the communications network are in fact known from the prior art. With these, the user enters for example a user identification and a password, as a result of which the user can be authenticated with some measure of certainty. With said methods, however, the communications unit used remains unknown to the communications network. This means it is not confirmed whether the communications unit used by the user—what is referred to as the “hardware”—is also authorized to access the services offered.

There are also methods known from the prior art which identify particular communications units via unique global identifiers, such as, for example, the assignment of globally unique MAC addresses to network cards in what is referred to as Ethernet traffic. However, these methods have the disadvantage that said identifiers are assigned openly and as a result misuse is easily possible. Thus, for example, a transmitted identifier can be forged or the identifier of a different communications unit can be used. Some of these identifiers, such as, for example, the above-mentioned MAC addresses, can be changed comparatively easily using appropriate software, as a result of which reliable and trustworthy authentication of communication units can no longer be performed. This means it is no longer possible to confirm whether a communications unit provided for the purpose is really connected to a communications network via an access point and whether said communications unit is authorized to use certain services.

### SUMMARY OF INVENTION

An object underlying the invention is therefore to specify a method by means of which a communications unit can be reliably identified.

This object is achieved according to the invention by means of a method for authenticating a communications unit wherein a secret codeword is programmed into a permanent memory for the purpose of reliable verification of said communications unit. During a registration or signing-on process of the communications unit with a service provider in a communications network, the secret codeword is used to generate a message which is sent to the service provider. On the basis of this message it can be verified whether the communications unit authenticated therewith is authorized to obtain the service.

In this way it is ensured that services of a communications network are only obtained with corresponding suitable communications units that are approved by the communications network operator. The codeword can advantageously be written in during manufacture, at the time of shipment or during the configuration of the communications unit.

It is favorable in this case if the codeword is implemented on a device-specific and manufacturer-specific basis and is made known only to the manufacturer of the communications unit and the service provider. This reduces the risk of the codeword being spied out or manipulated by unauthorized third parties. By means of the codeword that is known only to the manufacturer and the service provider it is also possible to check whether the communications unit is allowed to perform the respective service.

It is advantageous that an electronic hexadecimal expression is used as the codeword. This offers the advantage that the codeword can be further processed comparatively easily using popular programming languages such as, for example, JAVA or C++. Storing the codeword as a hexadecimal expression also offers the advantage of representing comparatively large expressions in a space-saving manner.

It is favorable if ideally a scattered form of storage according to the so-called MD5 hashing method or one-way hashing method is used for generating the message from the codeword. This is an encryption method in which the original codeword cannot be inferred from the result of the method. The codeword itself is not transmitted in the process.

An embodiment of the method is advantageous in so far as a variable component is used in addition to the codeword when the message is generated. This ensures that a message which differs from the preceding messages is generated for each authentication process of the communications unit. If, for example, the time of day is used as the variable component, the period of validity of the message can also be restricted in addition.

### BRIEF DESCRIPTION OF THE DRAWINGS

The invention is explained in more detail with reference to figures, in which, by way of example:

FIG. 1 shows the schematic flow of the authentication sequence of a communications unit in an exemplary communications network

FIG. 2 shows the schematic flow of how the message for authenticating the communications unit is generated

### DETAILED DESCRIPTION OF INVENTION

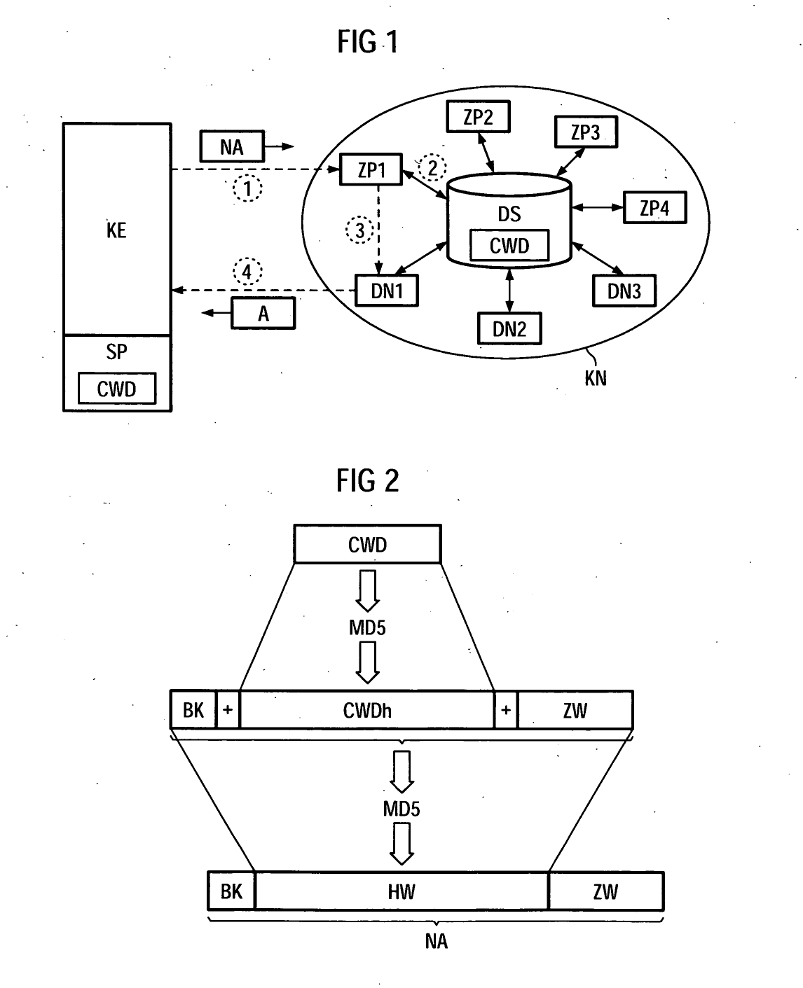

The exemplary communications network KN according to FIG. 1 comprises access points ZPx via which a communications unit KE can be connected by signing on to (registering with) the communications network KN. Also made available by the communications network KN are various services DNx by which is understood the capability of the communications network KN to transmit information of a particular type. Said services DNx may be, for example: voice transmission, access to the internet or companies' inhouse data networks and packet-oriented data transmission, the downloading, subject to payment of a fee, of music and video data made available on data stores by service providers, etc.

In order that these services DNx can be obtained with a communications unit KE, specific technical preconditions and/or requirements specified by the service provider must be fulfilled by said communications unit KE. If these preconditions and/or requirements are met, the communications unit KE is classified by the service provider as trustworthy. Only as a result thereof is the user authorized to use services DNx with the communications unit KE.

In order to enable a unique identification of the communications unit KE, a codeword CWD is programmed into a permanent memory SP of the communications unit KE during the manufacture of the communications unit KE. Said codeword CWD is preferably device-specific and known only to the manufacturer and the service provider so as thereby to reduce the risk of the codeword being spied out and tampered with by unauthorized third parties.

If a service DN1 of a communications network KN is now to be obtained, the user with the communications unit KE registers, in a first step 1, with the communications network KN at an access point ZP1. During this registration process the communications unit KE is also identified. Toward that end a message NA is generated by the communications unit KE using scattered storage according to the so-called MD5 hashing method MD5, which message serves exclusively to authenticate the communications unit KE and is sent in addition in step 1.

The information used for the purpose of generating this message NA comprises, according to FIG. 2, the user identification BK, which serves to register the user with the access point ZP1 of the communications network KN, a version CWDh, generated by the MD5 hashing method MD5, of the codeword CWD, and a random value ZW such as, for example, the time of day in order to prevent a repetition of the message NA and to restrict the period of validity of the message NA.

In this scheme the codeword CWDh generated according to the MD5 hashing method MD5 and the random value ZW are ideally defined as what are termed hexadecimal strings. These are alphanumeric character sequences consisting only of the symbols 0 to 9 and A to F.

The user identification BK, the codeword CWDh generated according to the MD5 hashing method MD5 and the random value ZW are added together and the MD5 hashing method is once again applied to the result. This yields an MD5 hash value HW which is again stored as a hexadecimal string and forms the middle part of the message NA transmitted by the communications unit KE to the access point ZP1 in step 1, which message NA is composed in its final version of the user identification BK, the MD5 hash value HW and the random value ZW.

This message NA is sent in step 1 by the communications unit KE to the access point ZP1 of the communications network KN. The access point ZP1 reads out the information transmitted in the message NA and interprets it. The first part of the message is identified as the user identification BK. The last part of the message is interpreted as the random value ZW.

The transmitted user identification BK and the transmitted random value ZW are used by the access point ZP1 in order to compute, using MD5 hashing method MD5, an MD5 hash value with the codeword CWD of the communications unit KE, which codeword CWD is also stored in the communications network KN, for example in a central data store DS, so as to be accessible to the access points ZPx. For this purpose the codeword CWD is fetched from the central data store DS in a step 2 by the access point ZP1.

The MD5 hash value determined by the access point ZP1 is compared with the MD5 hash value HW sent by the communications unit KE. If the value computed by the access point ZP1 matches the MD5 hash value HW sent by the communications unit KE and if the additionally sent random value ZW lies within a specified tolerance limit, then the communications unit KE is authorized to access the service DN1. The service DN1 is initiated by the access point ZP1 in a step 3, so that a corresponding response message A is sent to the communications unit KE in a step 4.

If the two values do not match, a response message A is transmitted in step 4 to the communications unit KE indicating that the use of the service with this communications unit is not allowed, as the communications unit KE is classified as not trustworthy.

1-8. (canceled)

9. A method for verifying a communications unit authorization for using a service in a communications network, comprising:
providing a stored codeword programmed into a permanent memory of the communications units;
generating a message during a registration of the communications unit with a service provider in the communications network, the message comprising a generated codeword, the stored codeword used to generate the generated codeword;
sending the generated message to the service provider; and
verifying that the communications unit is authorized to obtain the service via the generated codeword.

10. The method as claimed in claim 9, wherein the stored codeword is programmed into the permanent memory during a manufacture of the communications unit.

11. The method as claimed in claim 9, wherein the stored codeword is programmed into the permanent memory at a time of shipment of the communications unit.

12. The method as claimed in claim 9, wherein the stored codeword is programmed into the permanent memory during a configuration of the communications unit.

13. The method as claimed in claim 9, wherein the stored codeword is implemented on a device-specific and a manufacturer-specific basis and is made known only to the manufacturer of the communications unit and the service provider.

14. The method as claimed in claim 9, wherein an electronic hexadecimal expression is used as the codeword and for the generated message.

15. The method as claimed in claim 9, wherein the generated codeword is generated by encrypting the stored codeword.

16. The method as claimed in claim 15, wherein encryption is a scattered form of storage according to a MD5 hashing method.

17. The method as claimed in claim 15, wherein the generated message further comprises a user identification used in a registration of a user of the communications unit in the communications network.

18. The method as claimed in claim 17, wherein the generated message further comprises a variable component used to restrict a period of validity of the generated message.

19. The method as claimed in claim 17, wherein the variable component indicates a time of day.

20. The method as claimed in claim 9, further comprises initiating the service for the communications unit when the communications unit is authorized to obtain the service.

21. The method as claimed in claim 20, further comprises sending a response message to the communications unit.
